(19) United States
(12) Patent Application Publication
(10) Pub. No.: US 2025/0306614 A1
(43) Pub. Date: Oct. 2, 2025

(54) INTELLIGENT CONTROL METHOD AND APPARATUS FOR QUICK-OPEN PRESSURE-BEARING DEVICE SYSTEM

(71) Applicants: China National Petroleum Corporation, Beijing (CN); China Petroleum Pipeline Engineering Co., Ltd., Langfang (CN); China Petroleum Pipeline Machinery Manufacture Co., Ltd., Langfang City (CN); China Petroleum Pipeline Engineering Corporation, Langfang (CN)

(72) Inventors: Yunlan YANG, Langfang City (CN); Tao LIU, Langfang City (CN); Wenyong LI, Langfang City (CN); Feng ZOU, Langfang City (CN); Qingwei MENG, Langfang City (CN); Yanli FENG, Langfang City (CN); Meng LI, Langfang City (CN); Zheng ZHOU, Langfang City (CN)

(73) Assignees: China National Petroleum Corporation, Beijing (CN); China Petroleum Pipeline Engineering Co., Ltd., Langfang, HE (CN); China Petroleum Pipeline Machinery Manufacture Co., Ltd., Langfang City, HE (CN); China Petroleum Pipeline Engineering Corporation, Langfang, HE (CN)

(21) Appl. No.: 18/865,973

(22) PCT Filed: Dec. 15, 2022
(86) PCT No.: PCT/CN2022/139313

§ 371 Date: Nov. 14, 2024

(30) Foreign Application Priority Data
Dec. 14, 2022 (CN) 202211610478.7

(51) Int. Cl. G05D 16/20; G05B 13/02

(52) U.S. Cl. CPC G05D 16/2026; G05B 13/0265

(57) ABSTRACT

An intelligent control method and apparatus for a quick-open pressure-bearing device system is provided. The method comprises an intelligent integrated control system receiving an opening/closing instruction of a pressure-bearing device system. Upon receipt of an opening instruction, the intelligent integrated control system scans and reads an internal state of a pressure-bearing device and the reading of a pressure transmitter, and determines whether an opening condition is satisfied. If yes, the system sequentially controls functional systems to be automatically opened. If not, the system controls corresponding valves to be automatically closed, automatically determines whether to enter a blowdown process, and performs corresponding automatic blowdown or pressure relief processing and an opening process again after completion. Upon receipt of a closing instruction, the intelligent integrated control system sequentially controls the functional systems to be automatically closed. After the closing is completed, the system completes the opening of the pressure-bearing device system.

### CROSS REFERENCE TO RELATED APPLICATIONS

The present application claims the benefits of Chinese Patent Application No. 202211610478.7 filed on Dec. 14, 2022, the content of which is incorporated herein by reference.

### FIELD

The present disclosure relates to a pressure-bearing device system, in particular to an intelligent control method for a quick-open pressure-bearing device system. In addition, the present disclosure further relates to a pressure-bearing device system and an intelligent quick-open closure.

### BACKGROUND

Quick-open pressure-bearing device is important equipment that is to be opened frequently in pressure pipeline systems in oil and gas gathering and transferring stations, natural gas processing plants, gas storage depots, long-distance pipeline stations and urban oil and gas transmission and distribution stations, such as filtration and separation equipment, and pig detector releasing/receiving equipment, etc. Quick-open pressure-bearing device is connected with pipelines to form pressure-bearing device systems.

As the construction of intelligent pipelines and intelligent pipe networks is deepened persistently, management modes such as “one-button start and stop stations” and “unattended stations” have become new management modes of oil and gas pipeline systems. Therefore, intelligentization of quick-open pressure-bearing device and intelligent control of pressure-bearing device systems have become an important development direction in this field.

In view of that trend, it is necessary to provide an intelligent control method and an intelligent control device that can automatically control a quick-open pressure-bearing device system.

### SUMMARY

The technical problem to be solved in a first aspect of the present disclosure is to provide an intelligent control method for a quick-open pressure-bearing device system, which can realize safe and intelligent opening or closing of a pressure-bearing device system.

The technical problem to be solved in a second aspect of the present disclosure is to provide a pressure-bearing device system that has is at a high level of automation and can realize safe and automatic opening and closing of a quick-open closure.

The technical problem to be solved in a third aspect of the present disclosure is to provide an intelligent quick-open closure that has a simple structure and is at a high level of automation.

In order to solve the above technical problems, in a first aspect, the present disclosure provides an intelligent control method for a quick-open pressure-bearing device system, which comprises the following steps:
receiving an instruction for opening or closing the pressure-bearing device system, by an intelligent integrated control system;
if an opening instruction is received, scanning and reading states of all program-controlled valves in an internal state detection device and an indication of a pressure transmitter of a pressure-bearing device, and judging whether opening conditions for opening an intelligent quick-open closure are met, by the intelligent integrated control system;
if the opening conditions are met, sequentially controlling an automatic safety interlock system, an automatic locking system, and an automatic head cover opening and closing mechanism in the intelligent quick-open closure to automatically open, by the intelligent integrated control system, so as to complete the opening of the intelligent quick-open closure; in the opening process, continuously scanning and reading the states of all the program-controlled valves in the internal state detection device and the indication of the pressure transmitter of the pressure-bearing device, and judging whether conditions for opening or closing the intelligent quick-open closure are met, by the intelligent integrated control system; if the conditions are not met, carrying out automatic identification, diagnosis and handling, by the intelligent integrated control system; and sending an alarm signal, by the intelligent integrated control system, if the conditions can't be handled by itself;
if the opening conditions are not met, controlling a medium inlet valve and a medium outlet valve to close, and choosing whether to enter a blowdown process according to the operating condition of the pressure-bearing device, by the intelligent integrated control system; if blowdown is necessary, opening a relief valve in the internal state detection device of the pressure-bearing device, and reading the indication of the pressure transmitter continuously till a preset blowdown pressure is reached, then closing the relief valve, opening a blowdown valve in the internal state detection device of the pressure-bearing device for blowdown, then closing the blowdown valve after the blowdown is completed, opening the relief valve and continuously reading the indication of the pressure transmitter till the value is “0”, then closing the relief valve, locking all the program-controlled valves in an OFF state, and then executing the instruction for opening the intelligent quick-open closure again;
if blowdown is unnecessary, controlling the relief valve to open, and continuously reading the indication of the pressure transmitter till the value is “0”, then closing the relief valve, locking all the program-controlled valves in the OFF state, and then executing the instruction for opening the intelligent quick-open closure again, by the intelligent integrated control system;
if a closing instruction is received, sequentially controlling the automatic head cover opening and closing mechanism, the automatic locking system, and the automatic safety interlock system in the intelligent quick-open closure to automatically close, by the intelligent integrated control system, so as to complete the closing of the intelligent quick-open closure; automatically identifying and judging the states of all the program-controlled valves in the internal state detection device and the indication of the pressure transmitter of the pressure-bearing device, and sequentially controlling the medium outlet valve and the medium inlet valve to automatically open according to the instruction, by the intelligent integrated control system, so as to complete the opening of the pressure-bearing device system.

In a second aspect, the present disclosure provides a pressure-bearing device system using the intelligent control method for a quick-open pressure-bearing device system described in any of the above technical schemes. The pressure-bearing device system comprises an intelligent quick-open closure, a pressure-bearing device, an internal state detection device of the pressure-bearing device, and an intelligent integrated control system, wherein the intelligent quick-open closure is configured to be normally closed, and all of the automatic safety interlock system, the automatic locking system and the automatic head cover opening and closing mechanism in the intelligent quick-open closure are in a communicative connection with the intelligent integrated control system, and the internal state detection device of the pressure-bearing device is in a communicative connection with the intelligent integrated control system, so that the intelligent integrated control system controls the automatic safety interlock system, the automatic locking system and the automatic head cover opening and closing mechanism to act to open the intelligent quick-open closure when the internal state detection device of the pressure-bearing device is in a set state.

Furthermore, the pressure-bearing device is provided with a medium inlet end and a medium outlet end; the internal state detection device of the pressure-bearing device comprises a medium inlet valve arranged at the medium inlet end, a medium outlet valve arranged at the medium outlet end, a relief valve, a blowdown valve and a pressure transmitter, wherein all of the medium inlet valve, the medium outlet valve, the pressure transmitter, the relief valve, and the blowdown valve are in a communicative connection with the intelligent integrated control system.

Furthermore, the intelligent integrated control system comprises a control unit, an opening/closing instruction signal inputting and receiving module, a state display module and an alarm module, wherein all of the medium inlet valve, the medium outlet valve, the pressure transmitter, the relief valve, the blowdown valve, the opening/closing instruction signal inputting and receiving module, the state display module and the alarm module are in a communicative connection with the control unit, to enable displaying state information of the medium inlet valve, the medium outlet valve, the relief valve and the blowdown valve and value information of the pressure transmitter via the state display module, and analyze the state information and the value information via the control unit, so as to send an opening instruction to the opening/closing instruction signal inputting and receiving module to control the automatic safety interlock system, the automatic locking system and the automatic head cover opening and closing mechanism to open the intelligent quick-open closure when the state information meets a set state and the value information meets a set value.

In a third aspect, the present disclosure provides an intelligent quick-open closure, which is the intelligent quick-open closure described in any of the technical schemes provided above in the second aspect, and comprises an automatic safety interlock system, an automatic locking system, an automatic head cover opening and closing mechanism, an end flange and a head cover, wherein the automatic head cover opening and closing mechanism is connected with the head cover, and can drive the head cover to get close to or move away from the end flange; the automatic locking system comprises a locking structure and a locking driving unit connected with the locking structure; the end flange is provided with an end flange locking structure that matches the locking structure; the locking structure can be driven by the locking driving unit to get close to or move away from the end flange locking structure, and can force the head cover to abut against the end flange when the locking structure enters the end flange locking structure.

Furthermore, the locking structure comprises a plurality of arc-shaped locking petals, the end flange locking structure is a clamping groove arranged on the inner diameter of the end flange, the clamping groove is adapted to accommodate the head cover and the locking structure, and is fitted with an end face of the end flange to form a step structure, a head cover receiving part and a locking structure abutting part are formed on the clamping groove, so that the head cover is press-fitted between the head cover receiving part and the step structure when the locking structure abuts against the locking structure abutting part.

Furthermore, the locking driving unit comprises a push rod, a push rod stopper, a mounting bracket, a central control panel and a central control panel driving device, wherein the mounting bracket is arranged on the head cover, and the central control panel driving device is arranged on the mounting bracket and connected with the central control panel, so as to drive the central control panel to rotate; the central control panel is provided with a plurality of sliding slots, a plurality of push rods are provided, one end of each push rod is provided with a stress rod that can be inserted into one of the sliding slots, and the other end of each push rod is connected with a corresponding arc-shaped locking petal, so that the sliding slot abuts against the stress rod and drives the stress rod to drive the arc-shaped locking petal to move away from or get close to the end flange locking structure when the central control panel is rotated; each push rod is moved in a radial direction of the head cover, and at least one push rod stopper is arranged in the moving direction of each push rod.

Furthermore, the sliding slot extends from a central part of the central control panel to the edge of the central control panel, and, when the stress rod is moved toward an end of the sliding slot close to the central part of the central control panel, it can drive the push rod to move toward a central part of the head cover; when the stress rod is moved to an end of the sliding slot away from the central part of the central control panel, it can drive the push rod to move toward the edge of the head cover; and a rotary bearing is provided on a part of the stress rod where the stress rod contacts with the sliding slot.

Furthermore, the automatic head cover opening and closing mechanism comprises a head cover supporting member, an opening and closing mechanism driving device, and an opening and closing mechanism supporting member, wherein the automatic head cover opening and closing mechanism is connected with the end flange via the opening and closing mechanism supporting member, one end of the head cover supporting member is connected with the head cover, the other end of the head cover supporting member is hinged to the opening and closing mechanism supporting member, and the opening and closing mechanism driving device is connected with hinged portions of the head cover supporting member and the opening and closing mechanism supporting member so as to drive the head cover supporting member to rotate.

Furthermore, the automatic safety interlock system comprises a relief bolt, an interlocked moving block, an interlock system bracket and an interlock system driving device, wherein the interlock system bracket is arranged on the head cover, the interlock system driving device is arranged on the interlock system bracket and is in a transmissive connection with the relief bolt, so as to drive the relief bolt to screw into or screw out of the head cover; the relief bolt is provided with a stop notch, the interlocked moving block is connected with the push rod, so that the interlocked moving block can pass through the stop notch when the relief bolt is rotated to a passable position, and stop the movement of the interlocked moving block when the relief bolt is rotated to a stop position.

With the above technical scheme, the intelligent control method for a quick-open pressure-bearing device system provided in the first aspect of the present disclosure can safely and automatically control an intelligent quick-open closure pressure-bearing device according to the intelligent integrated control system; when the intelligent integrated control system receives a control instruction for opening or closing the intelligent quick-open closure from the pressure-bearing device, if the received control instruction is an opening instruction, the intelligent integrate control system scans and read the states of all program-controlled valves and the indication of a pressure transmitter, and judges whether conditions for opening the intelligent quick-open closure are met according to a scanning result; if the opening conditions are met, the intelligent integrate control system executes an opening process, in which the intelligent integrated control system sequentially controls an automatic safety interlock system, an automatic locking system and an automatic head cover opening and closing mechanism in the intelligent quick-open closure to automatically open the intelligent quick-open closure; in the opening process, the intelligent integrated control system continuously scans and reads the states of the program-controlled valves and the indication of the pressure transmitter in the internal state detection device of the pressure-bearing device, and judges whether the conditions for opening or closing the intelligent quick-open closure are met; if the conditions are not mot, the intelligent integrated control system carries out automatic identification, diagnosis and handling; and the intelligent integrated control system sends an alarm signal if the conditions can't be handled by itself; if the opening conditions are not met, a blowdown process of the pressure-bearing device may be executed, and the intelligent integrated control system judges whether blowdown is necessary; if blowdown is necessary, the intelligent integrated control system executes blowdown according to the blowdown process; when the indication of the pressure transmitter becomes “0” after the blowdown is completed, the intelligent integrated control system executes the opening process of the intelligent quick-open closure again; if blowdown is unnecessary, the intelligent integrated control system relieves the pressure inside the pressure-bearing device, and then executes the opening process of the intelligent quick-open closure when the pressure value is “0”; if an instruction for closing the intelligent quick-open closure is received, the intelligent integrated control system sequentially controls the head cover, the automatic locking system and the automatic safety interlock system in the intelligent quick-open closure to automatically close, so as to complete the closing of the intelligent quick-open closure; in that process, the intelligent integrated control system automatically identifies and judges the states of the program-controlled valves and the indication of the pressure transmitter in the internal state detection device of the pressure-bearing device, and sequentially controls the medium outlet valve and the medium inlet valve to automatically open according to the instruction, so as to complete the opening of the pressure-bearing device system.

The pressure-bearing device provided in the second aspect of the present disclosure has all the technical advantages of the above-mentioned intelligent quick-open closure, since it includes the intelligent quick-open closure in the above technical scheme; in addition, the internal state of the pressure-bearing device can be detected with the internal state detection device of the pressure-bearing device, and the internal state of the pressure-bearing device is fed back to a controller, so that the controller controls the automatic interlock system and the automatic locking system to unlock, and controls the automatic head cover opening and closing mechanism to open the normally closed intelligent quick-open closure when the internal state detection device of the pressure-bearing device detects that the internal state of the pressure-bearing device is a set state; in that way, whether the intelligent quick-open closure can be opened or not can be judged automatically, and the intelligent quick-open closure can be opened successfully, and the operation is highly automated and highly safe.

In the intelligent quick-open closure provided in the third aspect of the present disclosure, the automatic head cover opening and closing mechanism can drive the head cover to get close to or move away from the end flange, so as to realize the opening and closing of the intelligent quick-open closure; when the head cover is close to and attached to the end flange, the locking driving unit in the automatic locking system can drive the locking structure to get close to the end flange locking structure on the end flange, so that the head cover is forced to abuts against the edge flange and is locked on the end flange by means of the fitting between the locking structure and the end flange locking structure, to realize the closing and locking of the intelligent quick-open closure; moreover, the locking structure can be driven by the locking driving unit in the automatic locking system to move away from the end flange locking structure on the end flange to release the fitting between the locking structure and the end flange locking structure, thereby the intelligent quick-open closure is unlocked; in that way, the automatic head cover opening and closing mechanism can further drive the head cover to move away from the end flange to realize the unlocking and opening of the intelligent quick-open closure. The intelligent quick-open closure has a simple structure, a low failure rate, is easy to service, doesn't require manual operation in the unlocking/locking and opening/closing process, and has a high level of automation.

Other features and advantages of the present disclosure will be further detailed in the following embodiments.

### BRIEF DESCRIPTION OF THE DRAWINGS

FIG. 1 is a schematic logic diagram of opening a quick-open closure with the quick-open pressure-bearing device system control method in the present disclosure;

FIG. 2 is a schematic logic diagram of closing a quick-open closure with the quick-open pressure-bearing device system control method in the present disclosure;

FIG. 3 is a schematic structural view of the pressure-bearing device in the present disclosure;

FIG. 4 is a schematic structural diagram of the quick-open closure in the present disclosure; and

FIG. 5 is a schematic structural diagram of the locking system in the quick-open closure in the present disclosure.

Reference Numbers

| | |
|---|---|
| 11- automatic safety interlock system | 111 - relief bolt |
| 1111 - stop notch | 112 - interlocked moving block |
| 113 - interlock system bracket | 114 - interlock system driving device |
| 12 - automatic locking system | 121 - locking structure |
| 122 - push rod | 123 - push rod stopper |
| 124 - mounting bracket | 125 - central control panel |
| 1251 - sliding slot | 126 - central control panel driving device |
| 13 - automatic head cover opening and closing | 131 - head cover supporting member |
| mechanism | |
| 132 - opening and closing mechanism driving | 133 - opening and closing mechanism |
| device | supporting member |
| 14 - end flange | 141 - end flange locking structure |
| 15 - head cover | 2 - pressure-bearing device |
| 3 - internal state detection device of the | 31 - medium inlet valve |
| pressure-bearing device | |
| 32 - medium outlet valve | 33 - pressure transmitter |
| 34 - relief valve | 35 - blowdown valve |
| 4 - intelligent integrated control system | 41 - control unit |
| 42 - opening/closing instruction signal inputting | 43 - state display module |
| and receiving module | |
| 44 - alarm module | 1 - intelligent quick-open closure |

### DETAILED DESCRIPTION

In the present disclosure, it may be noted that the terms “arrange” and “connect” shall be interpreted in their general meanings, for example, a connection may be a fixed connection, a detachable connection, or an integral connection; may be a direct connection or an indirect connection via an intermediate medium, or internal communication between two elements or interaction between two elements, unless otherwise specified and defined explicitly. Those having ordinary skills in the art may interpret the specific meanings of the terms in the present disclosure in their context.

Some embodiments of the present disclosure will be detailed below with reference to the accompanying drawings. It may be understood that the embodiments described herein are only provided to describe and explain the present disclosure, but are not intended to constitute any limitation on the present disclosure.

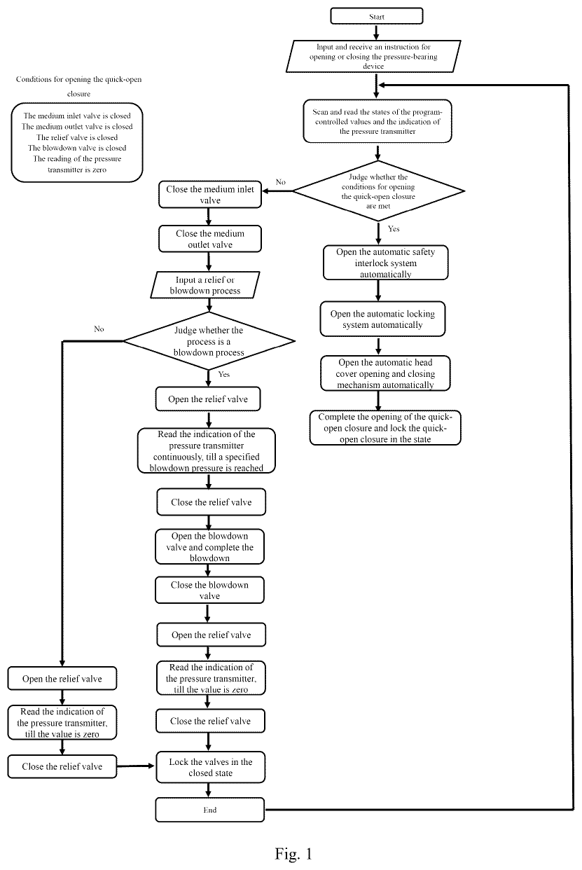

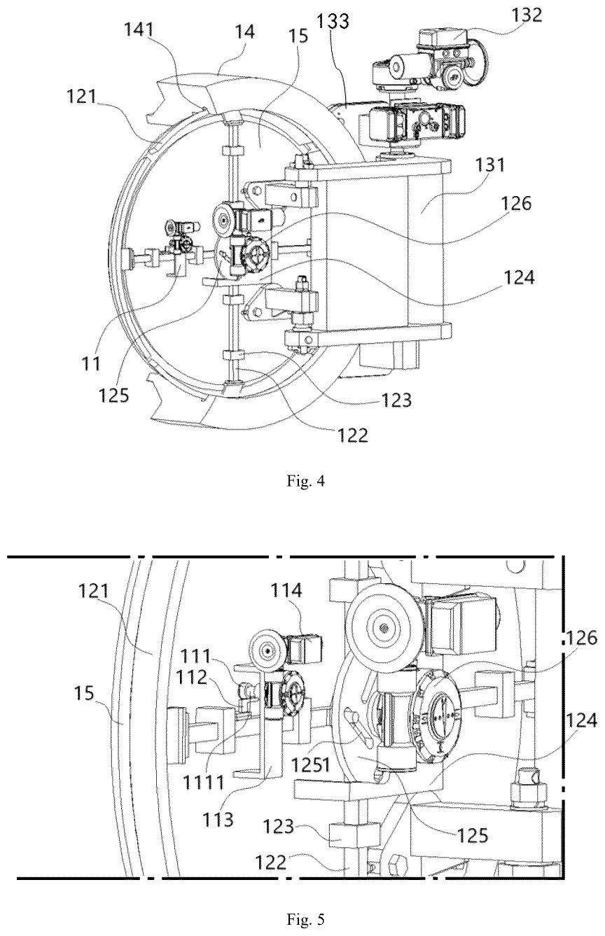

In a first aspect, the present disclosure provides a control method for a quick-open pressure-bearing system. Now, the control method will be described with reference to FIGS. 1 to 5 for better explanation. First, the intelligent integrated control system 4 receives an instruction for opening or closing the pressure-bearing device 2. If the received instruction is an opening instruction, the intelligent integrated control system 4 scans and reads the states of all program-controlled valves and the indication of a pressure transmitter 33 in an internal state detection device 3 of the pressure-bearing device; after the scanning, the intelligent integrated control system 4 judges whether the current state of the pressure-bearing device 2 meets conditions for opening the intelligent quick-open closure 1.

If the conditions for opening the intelligent quick-open closure 1 are met, the intelligent integrated control system 4 sequentially controls an automatic safety interlock system 11, an automatic locking system 12, and an automatic head cover opening and closing mechanism 13 in the intelligent quick-open closure 1 to automatically open, so as to complete the opening of the intelligent quick-open closure 1; in the opening process, the intelligent integrated control system 4 continuously scans and reads the states of all the program-controlled valves in the internal state detection device 3 and the indication of the pressure transmitter 33 of the pressure-bearing device, and judges whether conditions for opening or closing the intelligent quick-open closure 1 are met; if the conditions are not met, the intelligent integrated control system 4 carries out automatic identification, diagnosis and handling; and sends an alarm signal if the conditions can't be handled by itself;

If the conditions for opening the intelligent quick-open closure 1 are not met, the intelligent integrated control system 4 closes a medium inlet valve 31 and a medium outlet valve 32 sequentially, and then chooses whether to enter a blowdown process according to the operation condition of the pressure-bearing device 2; if blowdown is necessary, the intelligent integrated control system 4 opens a relief valve 34 to relieve the pressure inside the pressure-bearing device 2; in that process, the intelligent integrated control system 4 continuously detects the indication of the pressure transmitter 33; when the pressure is relieved to a preset blowdown pressure, the intelligent integrated control system 4 closes the relief valve 34 and opens a blowdown valve 35 for blowdown; after the blowdown, the intelligent integrated control system 4 closes the blowdown valve 35 and opens the relief valve 34 to continuously relieves the pressure inside the pressure-bearing device, till the indication of the pressure transmitter 33 becomes “0”; then the intelligent integrated control system 4 closes the blowdown valve 34, and executes the above control process again when the conditions for opening the intelligent quick-open closure 1 are met; if blowdown is unnecessary, the intelligent integrated control system 4 directly opens the relief valve 34 to relieve the pressure inside the pressure-bearing device, till the indication of the pressure transmitter 33 becomes “0”; then the intelligent integrated control system 4 closes the relief valve 34, and repeats the above-mentioned control process when the conditions for opening the intelligent quick-open closure 1 are met.
if a closing instruction is received, the intelligent integrated control system 4 sequentially controls the automatic head cover opening and closing mechanism 13, the automatic locking system 12, and the automatic safety interlock system 11 in the intelligent quick-open closure 1 to automatically close, so as to complete the closing of the intelligent quick-open closure 1; the intelligent integrated control system 4 automatically identifies and judges the states of all the program-controlled valves in the internal state detection device 3 and the indication of the pressure transmitter 33 of the pressure-bearing device, and sequentially controls the medium outlet valve 32 and the medium inlet valve 31 to automatically open according to the instruction, so as to complete the opening of the pressure-bearing device system.

In addition, when receiving an opening instruction next time, the intelligent integrated control system 4 will scan the states of all the program-controlled valves and adjust the states of the program-controlled valves first, to meet the conditions for opening the intelligent quick-open closure 1.

It may be noted that the program-controlled valves may include the medium inlet valve 31, the medium outlet valve 32, the relief valve 34 and the blowdown valve 35, and may further include other control valves, which may be configured according to the specific environment of use. In addition, for the above-mentioned intelligent integrated control system 4, a programmable controller or a distributed control system may be selected for programming according to specific application requirements.

The control method for a quick-open pressure-bearing system provided in the present disclosure realizes automatic control of a pressure-bearing device system, effectively reduces the labor intensity of operators and improves the working efficiency. Moreover, logic-compliant intelligent control of the pressure-bearing device is realized, thereby the safety and reliability are improved, and a prerequisite for realizing management modes such as “one-button start-stop station” and “unattended station” in oil and gas pipeline stations is provided.

With the above technical scheme, in the pressure-bearing device system provided in the second aspect of the present disclosure, the internal state of the pressure-bearing device 2 can be detected by means of the internal state detection device 3 of the pressure-bearing device, and the internal state of the pressure-bearing device 2 can be fed back to the intelligent integrated control system 4, so that the intelligent integrated control system 4 can control the automatic safety interlock system 11 and the automatic locking system 12 to unlock, and control the automatic head cover opening and closing mechanism 13 to open the normally closed intelligent quick-open closure 1 when the internal state detection device 3 of the pressure-bearing device detects that the internal state of the pressure-bearing device 2 is a set state; thus, the intelligent integrated control system 4 can automatically judge whether the intelligent quick-open closure 1 can be opened or not, and open the intelligent quick-open closure 1 successfully. Therefore, the device in the present disclosure is highly automated and highly safe.

Specifically, in an embodiment of the pressure-bearing device system provided in the second aspect of the present disclosure, as shown in FIG. 1, the pressure-bearing device 2 is provided with a medium inlet end and a medium outlet end, and the internal state detection device 3 of the pressure-bearing device comprises a medium inlet valve 31 arranged at the medium inlet end, a medium outlet valve 32 arranged at the medium outlet end, a relief valve 34, a blowdown valve 35, and a pressure transmitter 33; all of the medium inlet valve 31, the medium outlet valve 32, the pressure transmitter 33, the relief valve 34 and the blowdown valve 35 are in a communicative connection with the intelligent integrated control system 4 to feed back the current state, wherein the medium inlet valve 31 and the medium outlet valve 32 can feed back a valve opening and closing condition at the medium inlet end and the medium outlet end to the intelligent integrated control system 4, so as to judge whether there is a medium flowing into or flowing out of the pressure-bearing device 2. Both the relief valve 34 and the blowdown valve 35 are used to discharge the medium inside the pressure-bearing device 2, and can feed back the opening and closing states of the relief valve 34 and the blowdown valve 35 to the intelligent integrated control system 4. The pressure transmitter 33 is used to detect the pressure inside the pressure-bearing device 2 and can feed back the pressure value to the intelligent integrated control system 4, so that the intelligent integrated control system 4 can judge whether the conditions for opening the intelligent quick-open closure 1 are met according to the opening and closing states of the valves at the medium inlet end and the medium outlet end, the opening and closing states of the relief valve 34 and the blowdown valve 35, and the pressure inside the pressure-bearing device 2.

Furthermore, the preset blowdown pressure may be configured according to the actual situation of use. It may also be noted: in the specific implementation process, the conditions for opening the intelligent quick-open closure 1 can be met when the pressure value is slightly higher than the back pressure after the valve 34 is opened to relieve the pressure inside the pressure-bearing device 2.

Specifically, in an embodiment of the pressure-bearing device system provided in the second aspect of the present disclosure, as shown in FIG. 1, the intelligent integrated control system 4 comprises a control unit 41, an opening/closing instruction signal inputting and receiving module 42, a state display module 43 and an alarm module 44, wherein all the medium inlet valve 31, the medium outlet valve 32, the pressure transmitter 33, the relief valve 34 and the blowdown valve 35, the opening/closing instruction signal inputting and receiving module 42, the state display module 43 and the alarm module 44 are in a communicative connection with the control unit 41, so that the state information of the medium inlet valve 31, the medium outlet valve 32, the relief valve 34 and the blowdown valve 35 and the value information of the pressure transmitter 33 can be displayed via the state display module 43. The above-mentioned information can be used as a preliminary reference for the operator to issue an opening instruction for opening the intelligent quick-open closure 1 to the intelligent integrated control system 4. After the opening/closing instruction signal inputting and receiving module 42 receives an opening instruction, the control unit 41 analyzes the state information and the value information in real time to determine that the intelligent quick-open closure 1 can be opened if the state information conforms to a set state and the value information conforms to a set value, and sends an opening instruction to the opening/closing instruction signal inputting and receiving module 42 again to control the automatic locking system 112 and the automatic head cover opening and closing mechanism 13 to open the intelligent quick-open closure 1; If the state information does not conform to the set state and the value information does not conform to the set value, the control unit 41 will determine that it is necessary to keep the intelligent quick-open closure 1 in the normally closed state, and the alarm module 44 will give an alarm to prevent the operator from forcibly opening the intelligent quick-open closure 1.

Furthermore, in an embodiment of the pressure-bearing device system provided in the second aspect of the present disclosure, as shown in FIG. 1, the quick-open pressure-bearing system comprises the intelligent quick-open closure 1 in the above-mentioned technical scheme, and a pressure-bearing device 2, an internal state detection device 3 of the pressure-bearing device and an intelligent integrated control system 4, wherein the intelligent quick-open closure 1 is configured to be normally closed, and all the automatic safety interlock system 11, the automatic locking system 12 and the automatic head cover opening and closing mechanism 13 in the intelligent quick-open closure 1 are in a communicative communication with the intelligent integrated control system 4, so that the intelligent integrated control system 4 can control the operation of the automatic locking system 12 and the automatic head cover opening and closing mechanism 13; the internal state detection device 3 of the pressure-bearing device is used to detect the internal state of the pressure-bearing device 2 and is in a communicative connection with the intelligent integrated control system 4, so that the internal state of the pressure-bearing device 2 can be fed back to the intelligent integrated control system 4, and the intelligent integrated control system 4 can analyze the internal state of the pressure-bearing device 2; thus, when the internal state detection device 3 of the pressure-bearing device (i.e., the internal state of the pressure-bearing device 2) is in a set state, the intelligent integrated control system 4 controls the automatic locking system 12 and the automatic head cover opening and closing mechanism 13 to operate to open or close the intelligent quick-open closure 1.

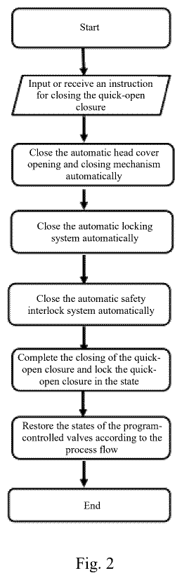

In an embodiment of the intelligent quick-open closure 1 provided in the third aspect of the present disclosure, as shown in FIG. 2, the intelligent quick-open closure 1 comprises an automatic safety interlock system 11, an automatic locking system 12, an automatic head cover opening and closing mechanism 13, an end flange 14 and a head cover 15, wherein the automatic head cover opening and closing mechanism 13 is connected with the head cover 15, and can drive the head cover 15 to get close to or move away from the end flange 14; the automatic locking system 12 comprises a locking structure 121 and a locking driving unit connected with the locking structure 121; the end flange 14 is provided with an end flange locking structure 141 that matches the locking structure 121; the locking structure 121 can be driven by the locking driving unit to get close to or move away from the end flange locking structure 141, and can force the head cover 15 to abut against the end flange 14 when the locking structure 121 enters the end flange locking structure 15.

With the above technical scheme, in the intelligent quick-open closure 1 provided in the third aspect of the present disclosure, the automatic head cover opening and closing mechanism 13 can drive the head cover 15 to get close to or move away from the end flange 14, so as to realize the opening and closing of the intelligent quick-open closure 1; when the head cover 15 is close to and attached to the end flange 14, the locking driving unit in the automatic locking system 12 can drive the locking structure 121 to get close to the end flange locking structure 141 on the end flange 14, so that the head cover 15 is forced to abuts against the edge flange and is locked on the end flange by means of the fitting between the locking structure 121 and the end flange locking structure 141, to realize the closing and locking of the intelligent quick-open closure 1; moreover, the locking structure 121 can be driven by the locking driving unit in the automatic locking system 12 to move away from the end flange locking structure 141 on the end flange 14 to release the fitting between the locking structure 121 and the end flange locking structure 141, thereby the intelligent quick-open closure 1 is unlocked; in that way, the automatic head cover opening and closing mechanism 13 can further drive the head cover 15 to move away from the end flange 14 to realize the unlocking and opening of the intelligent quick-open closure 1. The intelligent quick-open closure 1 has a simple structure, a low failure rate, is easy to service, doesn't require manual operation in the unlocking/locking and opening/closing process, and has a high level of automation.

Furthermore, in an embodiment of the intelligent quick-open closure 1 provided in the third aspect of the present disclosure, as shown in FIG. 2, the locking structure 121 includes a plurality of arc-shaped locking petals, and the end flange locking structure 141 is a clamping groove around the inner diameter of the end flange and can be fitted with the end face of the end flange to form a step structure; the clamping groove is adapted accommodate the head cover 15 and the locking structure 121, a head cover receiving part is formed on a side wall of the clamping groove, and a locking structure abutting part is formed on the bottom of the clamping groove, so that the head cover 15 can be press-fitted between the head cover receiving part and the step structure when the head cover 15 is connected with the head cover receiving part and the locking structure 121 abuts against the locking structure abutting part, thereby the intelligent quick-open closure 1 can be closed, wherein the step structure can exert pressure on the arc-shaped locking petals and the head cover 15 to ensure that the intelligent quick-open closure 1 will not be pushed open under the pressure inside the pressure-bearing device 2 after it is closed. It can be understood that a sealing element may be arranged on the side edge of the head cover 15, so that the sealing element can fill the space between the head cover 15 and the head cover receiving part to prevent the medium inside the pressure-bearing device 2 from leaking when the head cover 15 is press-fitted between the head cover receiving part and the step structure; four arc-shaped locking petals may be provided and uniformly distributed in the circumferential direction of the head cover 15, so that pressure can be uniformly applied to the head cover 15, thereby the entire edge of the head cover 15 can be in close contact with the head cover receiving part to prevent leakage.

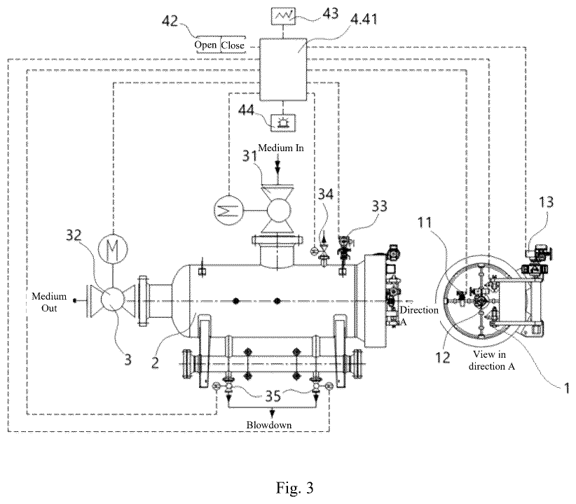

Furthermore, in an embodiment of the intelligent quick-open closure 1 provided in the third aspect of the present disclosure, as shown in FIGS. 2 and 3, the locking driving unit comprises a push rod 122, a push rod stopper 123, a mounting bracket 124, a central control panel 125 and a central control panel driving device 126, wherein the mounting bracket 124 is arranged on the head cover 15, and the central control panel driving device 126 is arranged on the mounting bracket 124 and is connected with the central control panel 125, so that the central control panel 125 can be driven to rotate; the central control panel 125 is arranged on the central part of the head cover 15; the central control panel 125 is provided with a plurality of sliding slots 1251; for example, according to the above technical scheme in which four arc-shaped locking petals are provided, four sliding slots 1251 may be provided, and four push rods 122 may be provided, so that the arc-shaped locking petals, the push rods 122 and the sliding slots 1251 can be in one-to-one correspondence. Specifically, one end of each push rod 122 is provided with a stress rod that can be inserted into a sliding slot 1251, and the other end of each push rod 122 is connected with a corresponding arc-shaped locking petal, so that the sliding slot 1251 abuts against the stress rod and drives the stress rod to drive the arc-shaped locking petal to move away from or get close to the end flange locking structure 141 when the central control panel 125 is rotated; preferably, the push rods 122 may be arranged to move in the radial direction of the head cover 15, at least one push rod stopper 123 is provided in the moving direction of each push rod 122, and the push rod stopper 123 may be configured to include two oppositely arranged stop claws and an anti-tilt stop lever connected between the two stop claws, so that the push rod stopper 123 can be connected with the head cover 15 via the two stop claws and the push rod 122 can be limited between the two stop claws to attain an effect of limiting and guiding the push rod 122; moreover, the anti-tilt stop lever can prevent the push rod 122 from tilting from the head cover 15, thus ensuring that the arc-shaped locking petals can be accurately pushed into the end flange locking structure 141 to close the intelligent quick-open closure 1.

Furthermore, in an embodiment of the intelligent quick-open closure 1 provided in the third aspect of the present disclosure, as shown in FIG. 3, the sliding slot 1251 extends from the central part of the central control panel 125 to the edge of the central control panel 125, and, when the stress rod is moved to an end of the sliding slot 1251 near the central part of the central control panel 125, it can drive the push rod 122 to move toward the central part of the head cover 15; when the stress rod is moved to an end of the sliding slot 1251 away from the central part of the central control panel 125, it can drive the push rod 122 to move to the edge of the head cover 15, wherein a rotary bearing is provided on a part of the stress rod where the stress rod contacts with the sliding slot 1251, so that the sliding friction between the stress rod and the sliding slot 1251 can be converted into rolling friction, thereby the frictional resistance is reduced and an energy-saving effect is achieved, and the service life of the stress rod and the sliding slot 1251 can be prolonged. In addition, the sliding slot 1251 may be configured into an arc-shaped slot, so that an included angle between the direction of the force exerted by the sliding slot 1251 on the stress rod (i.e., the direction perpendicular to the arc-shaped surface of the arc-shaped slot at a point on the sliding slot 1251 where the sliding slot 1251 contacts with the stress rod) and the moving direction of the push rod 122 is as small as possible, thereby the force required for rotating the central control panel 125 can be reduced, an energy saving effect can be attained, and the sliding friction between the stress rod and the sliding slot 1251 can be changed to rolling friction, thereby an effect of prolonging the service life of the stress rod and the sliding slot 1251 can be attained.

Furthermore, in an embodiment of the intelligent quick-open closure 1 provided in the third aspect of the present disclosure, as shown in FIG. 3, the automatic head cover opening and closing mechanism 13 comprises a head cover supporting member 131, an opening and closing mechanism driving device 132 and an opening and closing mechanism supporting member 133, wherein the automatic head cover opening and closing mechanism 13 is connected with the end flange 14 via the opening and closing mechanism supporting member 133, one end of the head cover supporting member 131 is connected with the head cover 15, and the other end of the head cover supporting member 131 is hinged to the opening and closing mechanism supporting member 133; the opening and closing mechanism supporting member 133 may be connected to the end flange 14, and the opening and closing mechanism driving device 132 is connected to hinged portions of the head cover supporting member 131 and the opening and closing mechanism supporting member 133, so that the head cover supporting member 131 can be driven to rotate, thereby the head cover 15 can be opened and closed; the opening and closing method employs a simple structure, and the automatic head cover opening and closing mechanism 13 can be configured to expand an opening angle between the head cover 15 and the end flange 14 up to 180 degrees, thereby the end flange 14 can be conveniently butt-jointed with other pipelines or other devices after the intelligent quick-open closure 1 is opened, and the interior of the pressure-bearing device 2 can be conveniently serviced through the end flange 14; the opening and closing mechanism driving device 132 may comprise a driving motor and a transmission shaft connected with the driving motor, the opening and closing mechanism supporting member 133 is provided with two bearing seats that are opposite to each other, the head cover supporting member 131 is provided with a sleeve structure, a transmission shaft is inserted through one bearing seat, the sleeve structure and the other bearing seat, and is fixedly connected with the sleeve structure, so as to form a hinge structure composed of the bearing seats, the transmission shaft and the sleeve structure (the head cover supporting member 131), thereby the head cover supporting member 131 can drive the head cover 15 to rotate and thereby close when the driving motor drives the transmission shaft to rotate.

Furthermore, in an embodiment of the intelligent quick-open closure 1 provided in the third aspect of the present disclosure, as shown in FIG. 3, the automatic safety interlock system 11 in the intelligent quick-open closure 1 comprises a relief bolt 111, an interlocked moving block 112, an interlock system bracket 113 and an interlock system driving device 114, wherein the interlock system bracket 113 is arranged on the head cover 15; the interlocking system driving device 114 is arranged on the interlock system bracket 113 and is in a transmissive connection with the relief bolt 111, so as to drive the relief bolt 111 to screw into or out of the head cover 15; the relief bolt 111 is provided with a stop notch 1111, and the interlocked moving block 112 is connected with the push rod 122, so that the interlocked moving block 112 can pass through the stop notch 1111 when the relief bolt 111 is rotated to a passable position; and the interlocked moving block 112 is restricted from moving when the relief bolt 111 is rotated to a stop position. Specifically, the diameter of a middle section of the relief bolt 111 may be configured to be smaller than the diameter of the two sections near the ends, so that the above-mentioned stop notch 1111 is formed at the middle section; when the relief bolt 111 is rotated to a position where the stop notch 1111 corresponds to the interlocked moving block 112, the interlocked moving block 112 can pass through the stop notch 1111, and, as a result, the push rod 122 connected with the interlocked moving block 112 is not restricted by the relief bolt 111 and can move back and forth; at that point, the automatic locking system 12 is in an unlocked state, and the intelligent quick-open closure 1 can be opened; when the relief bolt 111 is rotated to a position where the stop notch 1111 does not correspond to the interlocked moving block 112, the interlocked moving block 112 can't pass through the stop notch 1111, consequently the push rod 122 connected with the interlocked moving block 112 is blocked by the relief bolt 111, and, as a result, the locking structure 121 is locked in the end flange locking structure 141; thus, the head cover 15 can be locked to the end flange 14 after it is closed, the push rod 122 is prevented from getting loose accidentally, so that the head cover 15 can't be disengaged from the end flange 14, and no leakage will occur when the intelligent quick-open closure 1 is opened. Thus, the intelligent quick-open closure 1 has excellent safety performance.

While some preferred embodiments of the present disclosure are described above in detail with reference to the accompanying drawings, the present disclosure is not limited to those embodiments. Various simple variations may be made to the technical scheme in the present disclosure, including combinations of the specific technical features in any appropriate form, within the scope of the technical ideal of the present disclosure. To avoid unnecessary repetition, various possible combinations are not described specifically in the present disclosure. However, such simple variations and combinations shall also be deemed as having been disclosed and falling in the scope of protection of the present disclosure.

1. An intelligent control method for a quick-open pressure-bearing device system, comprising the following steps:
receiving an instruction for opening or closing the pressure-bearing device system, by an intelligent integrated control system;
if an opening instruction is received, scanning and reading states of all program-controlled valves in an internal state detection device and an indication of a pressure transmitter of a pressure-bearing device, and judging whether opening conditions for opening an intelligent quick-open closure are met, by the intelligent integrated control system;
if the opening conditions are met, sequentially controlling an automatic safety interlock system, an automatic locking system, and an automatic head cover opening and closing mechanism in the intelligent quick-open closure to automatically open, by the intelligent integrated control system, so as to complete the opening of the intelligent quick-open closure; in the opening process, continuously scanning and reading the states of all the program-controlled valves in the internal state detection device and the indication of the pressure transmitter of the pressure-bearing device, and judging whether conditions for opening or closing the intelligent quick-open closure are met, by the intelligent integrated control system; if the conditions are not met, carrying out automatic identification, diagnosis and handling, by the intelligent integrated control system; and sending an alarm signal, by the intelligent integrated control system, if the conditions can't be handled by itself;
if the opening conditions are not met, controlling a medium inlet valve and a medium outlet valve to close, and choosing whether to enter a blowdown process according to the operating condition of the pressure-bearing device, by the intelligent integrated control system; if blowdown is necessary, opening a relief valve in the internal state detection device of the pressure-bearing device, and reading the indication of the pressure transmitter continuously till a preset blowdown pressure is reached, then closing the relief valve, opening a blowdown valve in the internal state detection device of the pressure-bearing device for blowdown, then closing the blowdown valve after the blowdown is completed, opening the relief valve and continuously reading the indication of the pressure transmitter till the value is “0”, then closing the relief valve, locking all the program-controlled valves in an OFF state, and then executing the instruction for opening the intelligent quick-open closure again;
if blowdown is unnecessary, controlling the relief valve to open, and continuously reading the indication of the pressure transmitter till the value is “0”, then closing the relief valve, locking all the program-controlled valves in the OFF state, and then executing the instruction for opening the intelligent quick-open closure again, by the intelligent integrated control system;
if a closing instruction is received, sequentially controlling the automatic head cover opening and closing mechanism, the automatic locking system, and the automatic safety interlock system in the intelligent quick-open closure to automatically close, by the intelligent integrated control system, so as to complete the closing of the intelligent quick-open closure; automatically identifying and judging the states of all the program-controlled valves in the internal state detection device and the indication of the pressure transmitter of the pressure-bearing device, and sequentially controlling the medium outlet valve and the medium inlet valve to automatically open according to the instruction, by the intelligent integrated control system, so as to complete the opening of the pressure-bearing device system.

2. A pressure-bearing device system using the intelligent control method for a quick-open pressure-bearing device system of claim 1, comprising an intelligent quick-open closure, a pressure-bearing device, an internal state detection device of the pressure-bearing device, and an intelligent integrated control system, wherein the intelligent quick-open closure is configured to be normally closed, and all of the automatic safety interlock system, the automatic locking system and the automatic head cover opening and closing mechanism in the intelligent quick-open closure are in a communicative connection with the intelligent integrated control system, and the internal state detection device of the pressure-bearing device is in a communicative connection with the intelligent integrated control system, so that the intelligent integrated control system controls the automatic safety interlock system, the automatic locking system and the automatic head cover opening and closing mechanism to act to open the intelligent quick-open closure when the internal state detection device of the pressure-bearing device is in a set state.

3. The pressure-bearing device system of claim 2, wherein the pressure-bearing device is provided with a medium inlet end and a medium outlet end; the internal state detection device of the pressure-bearing device comprises a medium inlet valve arranged at the medium inlet end, a medium outlet valve arranged at the medium outlet end, a relief valve, a blowdown valve and a pressure transmitter, wherein all of the medium inlet valve, the medium outlet valve, the pressure transmitter, the relief valve, and the blowdown valve are in a communicative connection with the intelligent integrated control system.

4. The pressure-bearing device system of claim 3, wherein the intelligent integrated control system comprises a control unit, an opening/closing instruction signal inputting and receiving module, a state display module and an alarm module, wherein all of the medium inlet valve, the medium outlet valve, the pressure transmitter, the relief valve, the blowdown valve, the opening/closing instruction signal inputting and receiving module, the state display module and the alarm module are in a communicative connection with the control unit, to enable displaying state information of the medium inlet valve, the medium outlet valve, the relief valve and the blowdown valve and value information of the pressure transmitter via the state display module, and analyze the state information and the value information via the control unit, so as to send an opening instruction to the opening/closing instruction signal inputting and receiving module to control the automatic safety interlock system, the automatic locking system and the automatic head cover opening and closing mechanism to open the intelligent quick-open closure when the state information meets a set state and the value information meets a set value.

5. An intelligent quick-open closure, which is the intelligent quick-open closure of claim 2, and comprises an automatic safety interlock system, an automatic locking system, an automatic head cover opening and closing mechanism, an end flange and a head cover, wherein the automatic head cover opening and closing mechanism is connected with the head cover, and can drive the head cover to get close to or move away from the end flange; the automatic locking system comprises a locking structure and a locking driving unit connected with the locking structure; the end flange is provided with an end flange locking structure that matches the locking structure; the locking structure can be driven by the locking driving unit to get close to or move away from the end flange locking structure, and can force the head cover to abut against the end flange when the locking structure enters the end flange locking structure.

6. The intelligent quick-open closure of claim 5, wherein the locking structure comprises a plurality of arc-shaped locking petals, the end flange locking structure is a clamping groove arranged on the inner diameter of the end flange, the clamping groove is adapted to accommodate the head cover and the locking structure and is fitted with an end face of the end flange to form a step structure, and a head cover receiving part and a locking structure abutting part are formed on the clamping groove, so that the head cover is press-fitted between the head cover receiving part and the step structure when the locking structure abuts against the locking structure abutting part.

7. The intelligent quick-open closure of claim 6, wherein the locking driving unit comprises a push rod, a push rod stopper, a mounting bracket, a central control panel and a central control panel driving device, wherein the mounting bracket is arranged on the head cover, and the central control panel driving device is arranged on the mounting bracket and connected with the central control panel, so as to drive the central control panel to rotate; the central control panel is provided with a plurality of sliding slots, a plurality of push rods are provided, one end of each push rod is provided with a stress rod that can be inserted into one of the sliding slots, and the other end of each push rod is connected with a corresponding arc-shaped locking petal, so that the sliding slot abuts against the stress rod and drives the stress rod to drive the arc-shaped locking petal to move away from or get close to the end flange locking structure when the central control panel is rotated; each push rod is moved in a radial direction of the head cover, and at least one push rod stopper is arranged in the moving direction of each push rod.

8. The intelligent quick-open closure of claim 7, wherein the sliding slot extends from a central part of the central control panel to the edge of the central control panel, and, when the stress rod is moved toward an end of the sliding slot close to the central part of the central control panel, it can drive the push rod to move toward a central part of the head cover; when the stress rod is moved to an end of the sliding slot away from the central part of the central control panel, it can drive the push rod to move toward the edge of the head cover; and a rotary bearing is provided on a part of the stress rod where the stress rod contacts with the sliding slot.

9. The intelligent quick-open closure of claim 8, wherein the automatic head cover opening and closing mechanism comprises a head cover supporting member, an opening and closing mechanism driving device, and an opening and closing mechanism supporting member, wherein the automatic head cover opening and closing mechanism is connected with the end flange via the opening and closing mechanism supporting member, one end of the head cover supporting member is connected with the head cover, the other end of the head cover supporting member is hinged to the opening and closing mechanism supporting member, and the opening and closing mechanism driving device is connected with hinged portions of the head cover supporting member and the opening and closing mechanism supporting member so as to drive the head cover supporting member to rotate.

10. The intelligent quick-open closure of claim 9, wherein the automatic safety interlock system comprises a relief bolt, an interlocked moving block, an interlock system bracket and an interlock system driving device, wherein the interlock system bracket is arranged on the head cover, the interlock system driving device is arranged on the interlock system bracket and is in a transmissive connection with the relief bolt, so as to drive the relief bolt to screw into or screw out of the head cover; the relief bolt is provided with a stop notch, the interlocked moving block is connected with the push rod, so that the interlocked moving block can pass through the stop notch when the relief bolt is rotated to a passable position, and stop the movement of the interlocked moving block when the relief bolt is rotated to a stop position.
